(19) United States
(12) Patent Application Publication
(10) Pub. No.: US 2014/0215040 A1
(43) Pub. Date: Jul. 31, 2014

(54) Apparatus and Method for Network Control

(71) Applicants: Gang Liu, Shanghai (CN); Timothy Carey, Wylie, TX (US)

(72) Inventors: Gang Liu, Shanghai (CN); Timothy Carey, Wylie, TX (US)

(21) Appl. No.: 13/931,957

(22) Filed: Jun. 30, 2013

Related U.S. Application Data
(60) Provisional application No. 61/759,232, filed on Jan. 31, 2013.

(51) Int. Cl. H04L 12/24

(52) U.S. Cl. CPC H04L 41/0803
USPC 709/223

(57) ABSTRACT

A manner of facilitating management of remote devices, especially remote sensory devices, for example Zigbee devices, used in a home or small business. In one aspect, the present invention is a system for managing remote devices including an ACS and a proxy device, where the ACS and the proxy device are configured to communicate with each other at least in part using a data model including a data object and an associated device object. In a preferred embodiment, data object includes a network sub-object and an application sub-object.

### CROSS-REFERENCE TO RELATED APPLICATIONS

The present disclosure is related to and claims priority from U.S. Provisional Patent Applications Ser. Nos. 61/759,232 filed on 31 Jan. 2013 and 61/760,724 filed on 5 Feb. 2013, the entire contents of which are incorporated by reference herein.

### TECHNICAL FIELD

The present invention relates generally to the field of communication networks, and, more particularly, to a method and apparatus for managing remote devices of different types, especially devices that are used in home networks.

### BACKGROUND

The following abbreviations are herewith defined, at least some of which are referred to within the following description of the state-of-the-art and the present invention.
ACS Auto Configuration Server
BBF Broadband Forum
CPE Customer Premises Equipment
CWMP CPE WAN Management Protocol
GW Gateway
IEEE Institute of Electrical and Electronics Engineers
MAC Media Access Control
PAN Personal Access Network
PHY Physical [layer]
POS Personal Operating Space and the
TR Technical Report [a BBF term]
WAN Wide Area Network

Communication networks may be used for a wide variety of familiar applications such as telephone, email, and Internet service, and the reception of television and other programming In addition, communication networks also provide communications services for electronic devices to communicate with each other even in the absence of human interaction. For example, devices such as temperature sensors or smoke detectors in a home or office may communicate over such a network with a service established to monitor whatever conditions they are measuring. In some cases, a number of such remote devices also form a home network and communicate among themselves. Either way, a centrally-located server may the collect information from the remote devices or the network, and frequently controls or manages them as well.

A subscriber may use these remotely managed devices to, for example, monitor health indicators for one or more people at the subscriber's premises, automate functions such as heating and cooling, monitor energy use, or provide home security. The advantage of remotely managing these devices is that monitoring and control may be provided even when a subscriber is not home, is busy, or is for some reason incapacitated. The remote control also avoids problems associated with users who are not attentive or technically savvy; they are required to provide minimal or even no interaction for the service to function properly.

Note that many of these services may also be useful in the business or institutional settings, but for convenience herein the present invention will be described in terms of a home or residential subscriber and a home network. The centrally-located device that communicates with the remote devices over a communication network will herein be referred to as an ACS (auto configuration server). Many if not most home networks include a gateway device such as a home router that connects the devices in a home network to the external communication network, and hence to the ACS. A service provider may operate many ACSs, each of which may serve a large number of individual subscribers. As should be apparent, efficient and effective communication between an ACS and the remote devices it manages is of the utmost importance.

### SUMMARY

The present invention is directed to a manner of facilitating management of remote devices, especially remote sensory devices used in a home or small business. In one aspect, the present invention is a system for managing remote devices including an ACS and a proxy device where the ACS and the proxy device are configured to communicate with each other at least in part using a data model including a data object and an associated device object. In a preferred embodiment, data object includes a network sub-object and an application sub-object. The associated device object may include a network interface parameter to reference a network sub-object.

In a preferred embodiment, proxy device is operable according to a ZigBee protocol and the data object is a ZDO (ZigBee Data Object). In this embodiment, the system may also include a ZigBee Coordinator. The system may also include one or more ZigBee devices formed into a network by the ZigBee Coordinator.

In embodiments of the data object, for example a ZDO may also include a node descriptor and a power descriptor. Additional descriptors may be added to contain additional or user-defined information. In some embodiments, the network sub-object may also include an interface object and a node manager object, wherein the node manager object comprises routing tables. The network sub-object may also include a neighbor list. In some embodiments, the application object contains one or more of the following elements: bindings, application profiles, device profiles, group information, and security elements. The application object may also include a list of active endpoints.

In another aspect, the present invention is a method of device discovery in a home network such a ZigBee device network that may be initiated by an active scan over the channels specified in a ScanChannels argument for the period specified in a ScanDuration parameter. In one embodiment of this aspect every beacon frame received during the scan having a non-zero length payload is checked, for example by verifying the protocol ID that it matches the ZigBee protocol identifier, the addressing information of the beaconing device, whether or not it is permitting association. Then the scanning device may then copy the relevant information from each received beacon into its neighbour table. In this aspect, the data model also includes a device discovery object.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating a remote management network 100;

FIG. 2 is a simplified schematic diagram illustrating a remote management network 200 using ZigBee as a proxy protocol according to the prior art; and

FIG. 3 is a block diagram illustrating a data model 300 according to an embodiment of the present invention.

### DETAILED DESCRIPTION

The present invention is directed to a manner of facilitating management of remote devices, especially remote sensory devices used in a home or small business. As mentioned above, the efficient and effective communication between such devices and an ACS or other managing server is very important.

To enable communication within a home network, various standard protocols have been promulgated, for example IEEE 802.15.4. Communications protocols are frequently for convenience organized into “layers”, where each layer handles different aspects of the communication function. IEEE 802.15.4 is directed at what are known as the lower layers, including the PHY (physical) layer and the MAC (media access control) layer, and provides for a low-speed, generally close-range protocol for device to device communications.

Higher layers are not addressed by IEEE 802.15.4, but are left for specification by other standards. One such protocol is ZigBee, which defines higher layer protocols for home networks, including the APL (application) and NWK (network) layers. Note that although the ZigBee protocol will be referred to in this description, the present invention may also be used with other proxy protocols to the extent that it is applicable.

Remote management is advantageous to operate home network devices, such as those operating according to a ZigBee protocol, in a stable way. Remote management of such devices may be accomplished using the protocols specified in Broadband Forum's TR-069. TR-069 is widely used for remote management of end-user devices; it implements remote management functions of non-IP devices via CPE (customer premises equipment) proxy. Note that although the TR-069 protocol will be referred to in this description, the present invention may also be used with other protocols to the extent that it is applicable.

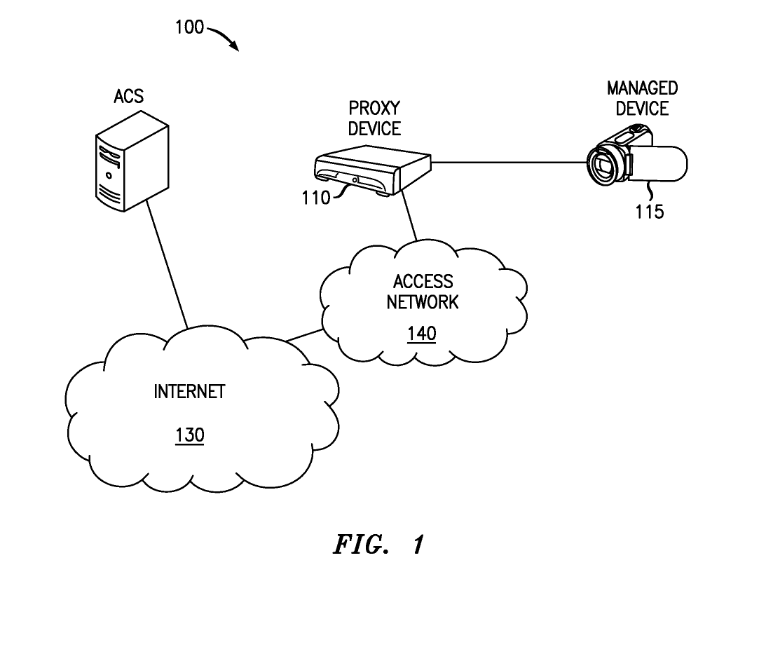

FIG. 1 is a simplified schematic diagram illustrating a remote management network 100. In this example, network 100 includes a managed device 115, which may for example be a security camera, and a management server 105, which herein is referred to as an ACS. The ACS 105 and the managed device 115 exchange various information and upgrades, communicating through proxy device 110. In a typical arrangement, the ACS communicates with the proxy device over the Internet 130 and an access network 140 using an Internet protocol, and the proxy device 110 communicates with the managed device 115 using, for example, a ZigBee protocol. Other proxy protocols that may be used include UPnP DM and Z-Wave.

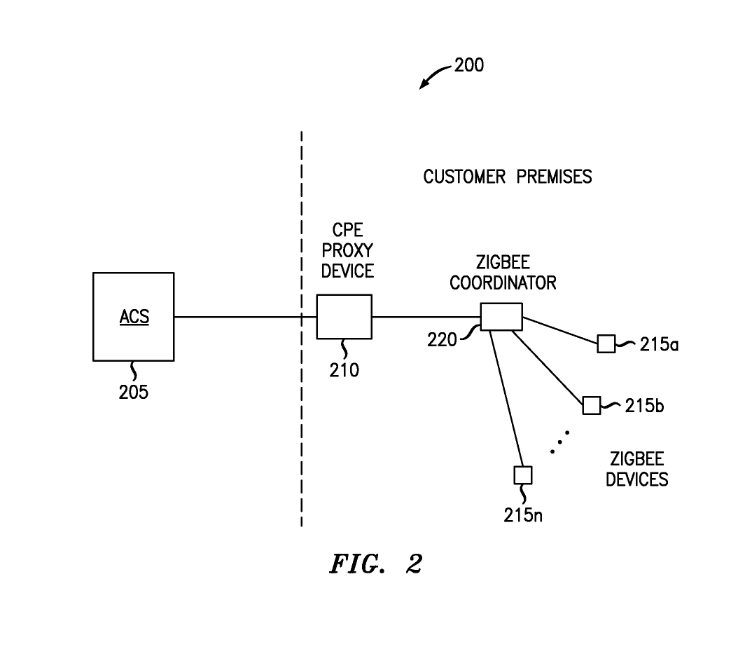

In implementations using TR-069, a protocol called CWMP is employed to carry management messages back and forth between the ACS 105 and the proxy device 110. (Note that if the managed device 115 were a CWMP end point, proxy device 110 would not be needed, but many devices are not.) An example of this arrangement using a ZigBee proxy protocol is shown in FIG. 2.

FIG. 2 is a simplified schematic diagram illustrating a remote management network 200 using ZigBee as a proxy protocol according to the prior art. As should be apparent, network 200 is similar to the network 100 shown in FIG. 1. In FIG. 2, ACS 205, typically at a remote site, communicates with a CPE proxy device 210 using CWMP message handling (the internetwork connection path is not shown in detail in FIG. 2). In this network 200, CPE proxy device 210 may be a residential GW such as the broadband router found in many homes today.

In the network of FIG. 2, CPE proxy device 210 then communicates with a ZigBee Coordinator 220, which is not an uncommon configuration. The ZigBee Coordinator 220 may act as a network controller forming a network of ZigBee devices. These communications are executed using a ZigBee protocol. The same is true of the communications between the ZigBee Coordinator 220 and individual ZigBee devices 215a through 215n. Note that in some embodiments, the CPE proxy device 210 may communicate directly with devices 215a through 215n; again using a ZigBee protocol.

In either case, in network 200, therefore, the CPE proxy device 210 must change received downstream CWMP messages into a format suitable for communicating via the Zigby proxy protocol. The ZigBee protocol utilizes a data object based message. The ZigBee device object, or ZDO, is used for communications between the CPE proxy device 210 and the ZigBee Coordinator 220, and between the ZigBee Coordinator and the individual ZigBee devices 215a through 215n. Naturally, the CPE proxy device 210 also must change upstream messages from these devices into CWMP messages for communicating to the ACS 205.

In the network of FIG. 2, a data model is employed to communicate between the ACS 205 and the CPE proxy device 210. The data model employed of course influences the performance and capability of the management function. A data model according to the present invention will now be described.

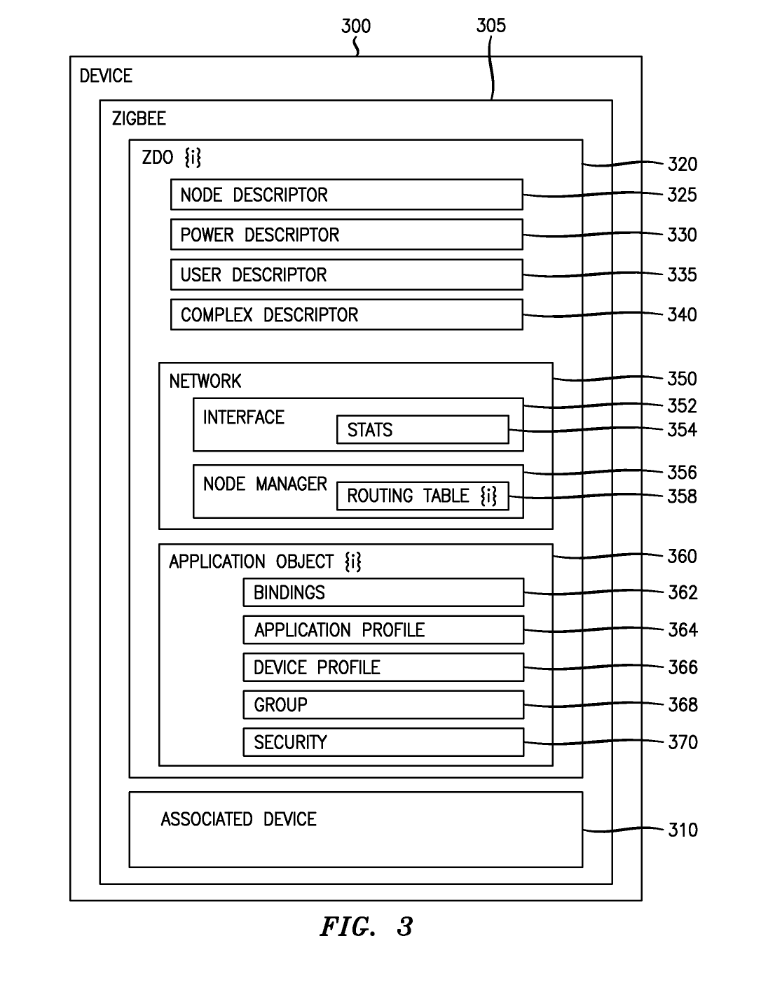

FIG. 3 is a block diagram illustrating a data model 300 according to an embodiment of the present invention. Note that FIG. 3 is a graphic representation of the logical organization of data for the transmission and reception of data, which is important for coherent communication between the relevant devices. Notice that data model 300 may be configured for any device, though only the configuration 305 for a ZigBee device is shown although its principles may be applicable to use with other proxy protocols as well. Data model 300 and configuration 305 are for convenience collectively referred to as the ZigBee data model of the present invention.

In this embodiment, the configuration 305 of data model 300 includes ZDO {i} 320, that is, the ZigBee Device Object. This is a multi-instance object in that it may occur for each node in a ZigBee network. ZigBee configuration 305 also includes an Associated Device object 310.

The ZDO {i} 320 according to this embodiment includes Node Descriptor 325 for describing the type and capabilities of each proxied device, Power Descriptor 330 for describing each devices power characteristics, User Descriptor 335 for user-definable information with respect to a given device, and Complex Descriptor 340 for use if necessary to provide additional descriptive information about each device.

In this embodiment, ZDO {i} 320 also includes a Network sub-object 350 and a multi-instance Application sub-object {i} 360. The Network sub-object 350 is not a multi-instance object in this embodiment as a ZigBee device cannot normally join multiple networks. In this embodiment, the Network sub-object 350 includes an Interface object 352 for modeling BBF specific interface stack properties including Enable, Status, Alias, Name, LastChange, and LowerLayers. Interface object 352 also includes a Stats sub-object 354.

In the embodiment of FIG. 3, the Network sub-object 350 also includes a Routing Table {i} sub-object 358 within the Node Manager sub-object 356. Although not shown in FIG. 3, Network sub-object 350 may also include a Network Address sub-object and a Neighbor list.

In this embodiment, Application sub-object {i} 360 includes sub-objects for Bindings 362, Application Profiles 364, Device Profiles 366, Groups 368 and Security Elements 370. Although not shown in FIG. 3, Application sub-object {i} 360 may also include a sub-object for Active Endpoints.

In the embodiment of FIG. 3, the AssociatedDevice object 310 is designated to describe remote ZigBee nodes that can be accessed via the ZigBee interface. In this embodiment, AssociatedDevice object 310 uses a new reference parameter NetworkInterface (not shown in FIG. 3) to reference the Network object of the ZDO instance table. In addition, the AssociatedDevice object 310 would contain the NetworkAddress and IEEEAddress parameters (which are the parameters that uniquely identify the Node) to address the situation where the AssociatedDevice does not have ZigBee ZDO{i} reference.

In one embodiment the AssociatedDevice object hierarchy is:

| | | | | |
|---|---|---|---|---|
| NetworkInterface | String | 256 | R | The NetworkInterface the |
| | | | | pathname of the |
| | | | | ZDO.{i}.Network object |
| | | | | that represents the network layer |
| | | | | properties of this object. |
| | | | | If the referenced object is |
| | | | | deleted, the corresponding item |
| | | | | MUST be removed from the list. |
| NetworkAddress | string | 8 | R | The network address field |
| | | | | specified 2 octets network |
| | | | | address of the ZigBee device, |
| | | | | such as “0x0001” or “0xFFFF”. |
| IEEEAddress | string | 32 | R | The MAC address (IEEE |
| | | | | address) field specified 8 |
| | | | | octets MAC address of the |
| | | | | ZigBee device, such as |
| | | | | “12:34:56:78:9A:BC:DE:F0” or |
| | | | | “FF:FF:FF:FF:FF:FF:FF:FF”. |

In an alternate embodiment (not shown), discovery is also provided for in the data model. Device or network discovery is the procedure whereby, for example, a ZigBee device can discover other devices and networks, if any, that are operational in its POS (Personal Operating Space). In this alternate embodiment, discovery will be accommodated using a DeviceDiscovery object. The DeviceDiscovery object may be, for example, a sub-object of an Interface object.

In this embodiment, using the DeviceDiscovery object the procedure for device discovery may be initiated by an active scan over the channels specified in a ScanChannels argument for the period specified in a ScanDuration parameter. Every beacon frame received during the scan having a non-zero length payload is checked, such as verify the protocol ID that it matches the ZigBee protocol identifier, the addressing information of the beaconing device, whether or not it is permitting association, etc. Then the scanning device shall copy the relevant information from each received beacon into its neighbour table.

Although not illustrated separately, an ACS according to an embodiment of the present invention includes a processor for executing program instruction and controlling at least some of the other components of the ACS. The ACS also includes a memory device for storing data and program instructions, executable by the processor, for operation according to embodiments of the invention. The ACS according to this embodiment also includes at least one network interface for communicating via a communications network such as the Internet.

Although not illustrated separately, a proxy device according to an embodiment of the present invention includes a processor for executing program instruction and controlling at least some of the other components of the proxy device. The proxy also includes a memory device for storing data and program instructions, executable by the processor, for operation according to embodiments of the invention. The proxy device according to this embodiment also includes at least one network interface for communicating via a communications network such as the Internet, and for communicating with a home network.

In each of these components, the memory device is at least in part a physical device, though a software component may be present for certain operations. The memory device is non-transitory in the sense that it is not merely a propagating signal. The processor is likewise implemented in hardware, or in hardware executing software program instruction, of a combination of both.

In this manner communications between a managing server or ACS and a proxy device are improved by providing flexibility and capabilities through use of the new data model described herein.

Note that although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A system for managing remote devices, comprising:
an ACS; and
a proxy device;
wherein the ACS and the proxy device are configured to communicate with each other at least in part using a data model, the data model comprising:
a data object comprising a network sub-object and an applications sub-object; and
an associated device object comprising a network interface parameter to reference a network sub-object.

2. The system of claim 1, wherein the data object further comprises a node descriptor and a power descriptor.

3. The system of claim 1, wherein the network sub-object further comprises an interface object and a node manager object, wherein the node manager object comprises routing tables.

4. The system of claim 3, the network sub-object further comprises a neighbor list.

5. The system of claim 1, wherein the application object contains bindings, application profiles, device profiles, group information, and security elements.

6. The system of claim 5, wherein the application object further contains a list of active endpoints.

7. The system of claim 1, wherein the proxy device is operable according to a ZigBee protocol and the data object is a (ZDO) ZigBee Data Object.

8. The system of claim 7, further comprising a ZigBee Coordinator.

9. The system of claim 1 further comprising a device discovery object.
